(19) United States
(12) Patent Application Publication
(10) Pub. No.: US 2005/0150203 A1
(43) Pub. Date: Jul. 14, 2005

(54) Multilinear fronted machine with rotary elements for cutting corn

(76) Inventor: Agostinho Vilaca Da Cunha, Barcelos (PT)

Correspondence Address: LADAS & PARRY, 26 WEST 61ST STREET, NEW YORK, NY, 10023, US

(21) Appl. No.: 10/506,938

(22) PCT Filed: Mar. 7, 2003
(86) PCT No.: PCT/PT03/00003

(30) Foreign Application Priority Data
Mar. 8, 2002 (PT) 102738

(51) Int. Cl. A01D 34/00

(52) U.S. Cl. 56/500

(57) ABSTRACT

The invention relates to a multilinear fronted machine comprising rotary elements for cutting corn. The inventive machine is intended to cut corn and, simultaneously, to insert said corn into a silo filler. Said machine comprises a reversal box (1), a toothed wheel (2), a clutch (3), a groove (4), four outlet boxes (5), two boxes with one outlet (6), two drums (7), two rotary elements (8), a clutch (9), boxes (10), two grooves (11), cutting elements (12), two lateral guides (13), nine guides (14), an angle piece (15) and corn inlet guides (16).

### OBJECT OF THE INVENTION

The present invention relates to a mechanized method that has a new effective technical design at a low price for cutting corn for ensilage and opening of pathways, with an advantage as regards increase of productivity once the machine cuts three rows in each pass.

In addition, the existence of rotary elements maintains consistently perfect and homogeneous cutting of the corn plants, and they eliminate the ingress of weeds, which are often the main causes of poor quality verified in ensilages.

### FIELD OF APPLICATION OF THE OBJECT OF THE INVENTION

The field of application of the present invention the cutting of corn for opening of pathways, which is designed to cut the corn and simultaneously to insert it into the silo filler, which in this way makes it possible to achieve a spectacular increase in productivity, placing this machine at the level of the best three-row automatic machines, but with very low purchase costs.

### THE PRIOR ART

It is noted that this is the first mechanized method for cutting corn and simultaneously inserting into the silo filler.

### DESCRIPTION OF THE DRAWINGS

FIG. 1: Perspective view of the multilinear machine.

FIG. 2: Side view of the multilinear machine attached to the silo filler.

FIG. 3: Main view of the silo filler attached to the multilinear machine.

### DESCRIPTION OF THE OBJECT OF THE INVENTION

The multilinear fronted machine with rotary elements for cutting corn—is designed to cut the corn and simultaneously insert it into the silo filler.

The multilinear fronted machine with rotary elements for cutting corn comprises a reversal box (1), a toothed wheel (2), a clutch (3), a groove (4), four outlet boxes (5), two boxes with one outlet (6), two drums (7), two rotary elements (8), a clutch (9), boxes (10), two grooves (11), cutting elements (12), two lateral guides (13), nine guides (14), an angle piece (15), corn inlet guides (16).

The multilinear fronted machine with rotary elements for cutting corn was designed to be attached to the silo filler (FIGS. 2 and 3). Its application permits two working positions relative to the tractor: lateral and reverse operation.

1. A multilinear fronted machine with rotary elements for cutting corn is characterized by the fact that it has two drums equipped with two rotary elements, six gearboxes, two clutches, twelve corn-cutting blades, a movement-reversal box, a toothed double pinion, two boxes with one outlet and pinions.

2. A multilinear fronted machine with rotary elements for cutting corn, according to claim 1, characterized by the fact that it has a reversal box (1), which receives the movement of the silo filler machine toward the power take-off pinion and reverses the movement, which transmits it to the toothed wheel (2) and this transmits to the clutch.

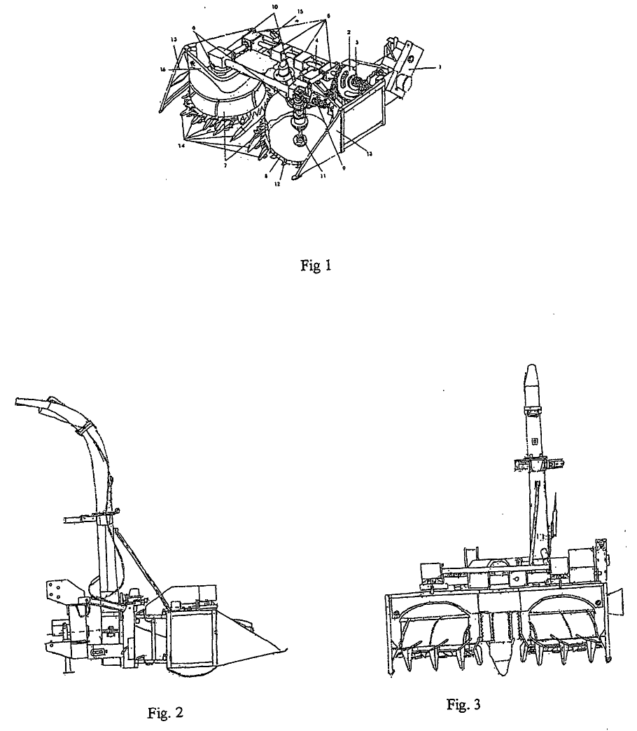

3. A multilinear fronted machine with rotary elements for cutting corn, according to claim 1, characterized by the fact that it has a clutch (3), which not only transmits the movement to the groove (4) and this transmits to the pinions of the four outlet boxes (5)—FIG. 1, but also functions as an overload limiter (3).

4. A multilinear fronted machine with rotary elements for cutting corn, according to claim 1, characterized by the fact that it has two boxes with one outlet (6), which transmit the movement to the drums (7).

5. A multilinear fronted machine with rotary elements for cutting corn, according to claim 1, characterized by the fact that it has two drums (7) equipped with rotary elements (8).

6. A multilinear fronted machine with rotary elements for cutting corn, according to claim 1, characterized by the fact that it has a double toothed wheel joined to the groove (4), which transmits the movement to the clutch (9).

7. A multilinear fronted machine with rotary elements for cutting corn, according to claim 1, characterized by the fact that it has two grooves (11), which transmit the movement from the boxes (10) to the elements (8), each of which contains six cutting blades (12).

8. A multilinear fronted machine with rotary elements for cutting corn, according to claim 1, characterized by the fact that it has a chassis constructed of structural tube, which endows the machine with double performance and a large reduction of weight.

9. A multilinear fronted machine with rotary elements for cutting corn, according to claim 1, characterized by the fact that it has two lateral guides (13).

10. A multilinear fronted machine with rotary elements for cutting corn, according to claim 1, characterized by the fact that it has nine guides (14), one central guide, four left guides and four right guides, all capable of being dismantled, and fixed by bolts and which function as protection.

11. A multilinear fronted machine with rotary elements for cutting corn, according to claim 1, characterized by the fact that it has an angle piece (15) with two spindles, which makes the connection of the multilinear fronted machine to the silo filler machine.

12. A multilinear fronted machine with rotary elements for cutting corn, according to claim 1, characterized by the fact that it has a protective element and corn inlet guides (16) toward the silo filler machine.

13. A multilinear fronted machine with rotary elements for cutting corn, according to claim 1, characterized by the fact that it permits adaptation to the silo filler machine via an angle piece (15).

14. A multilinear fronted machine with rotary elements for cutting corn, according to claim 1, characterized by the fact that it has two rotary cutting elements (12) whose rotation is 20 times faster than the drums (7).
